(19) United States
(12) Patent Application Publication
(10) Pub. No.: US 2013/0276375 A1
(43) Pub. Date: Oct. 24, 2013

(54) DOOR ASSEMBLY WITH DAMPING MATERIAL

(71) Applicants: Aaron R. Carmona, Santo Andre (BR); Frank J. Arabia, JR., Macomb, MI (US)

(72) Inventors: Aaron R. Carmona, Santo Andre (BR); Frank J. Arabia, JR., Macomb, MI (US)

(73) Assignee: GM GLOBAL TECHNOLOGY OPERATIONS LLC, Detroit, MI (US)

(21) Appl. No.: 13/452,097

(22) Filed: Apr. 20, 2012

(51) Int. Cl. B60J 5/04; E05B 3/00

(52) U.S. Cl. 49/460; 292/336.3

(57) ABSTRACT

A door assembly is provided with a handle that is movable between a first handle position where the door assembly is unlatched and a second handle position where the door assembly is latched. The handle may also be movable to a third handle position where the door assembly is locked. A hollow conduit is operatively connected to the handle at a first end. A wire is disposed within the conduit and operatively connected to the handle such that the wire translates within the conduit when the handle is moved. A damping material is positioned between an outer surface of the wire and an inner surface of the conduit. The damping material is configured to dampen the motion of the handle. In one example, the damping material is silicone grease.

### TECHNICAL FIELD

The invention relates generally to a door assembly and more particularly, to a door assembly for a vehicle.

### BACKGROUND OF THE INVENTION

A typical vehicle has at least one access door. Such a door typically has an exterior or interior door handle to gain access to the interior of the vehicle. The exterior or interior door handle typically actuates a latch mechanism in order to latch and unlatch the door.

### SUMMARY OF THE INVENTION

A door assembly is provided with a handle that is movable between a first handle position where the door assembly is unlatched and a second handle position where the door assembly is latched. The handle may also be movable to a third handle position where the door assembly is locked. A hollow conduit is operatively connected to the handle. A wire is disposed within the conduit and operatively connected to the handle such that the wire translates within the conduit when the handle is moved. A damping material is positioned between an outer surface of the wire and an inner surface of the conduit. The damping material is positioned and configured to dampen the motion of the handle. The transition of the handle between each of its positions is made smooth by the damping material. The damping material may prevent the handle from snapping into the third handle position when released with great force from the first handle position.

A latch mechanism may be operatively connected to the wire such that the translation of the wire within the conduit actuates at least one component of the latch mechanism in order to selectively unlatch, latch and lock the door assembly.

In one embodiment, the damping material is silicone grease. The silicone grease may be composed of polydimethylsiloxane combined with polytetrafluoroethylene. Alternatively, the silicone grease may be composed of polydimethylsiloxane combined with amorphous fumed silica.

In another embodiment, the damping material has a viscosity that is between approximately 225,000 cP and 325,000 cP at 25° C. The damping material may have a viscosity that is approximately 275,000 cP at 25° C. In another embodiment, the damping material has a dropping point of at least 200 Celsius.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective partial view of a vehicle door assembly having a handle, cable assembly and latch mechanism in accordance with the present disclosure;

FIG. 2 is a schematic sectional view of the cable assembly shown in FIG. 1;

FIG. 3 is a schematic sectional view of the handle shown in FIG. 1 in a first handle position;

FIG. 4 is a schematic sectional view of the handle shown in FIG. 1 in a second handle position;

FIG. 5 is a schematic sectional view of the handle shown in FIG. 1 in a third handle position; and

FIG. 6 is a schematic sectional view of the latch mechanism shown in FIG. 1.

### DESCRIPTION OF THE PREFERRED EMBODIMENTS

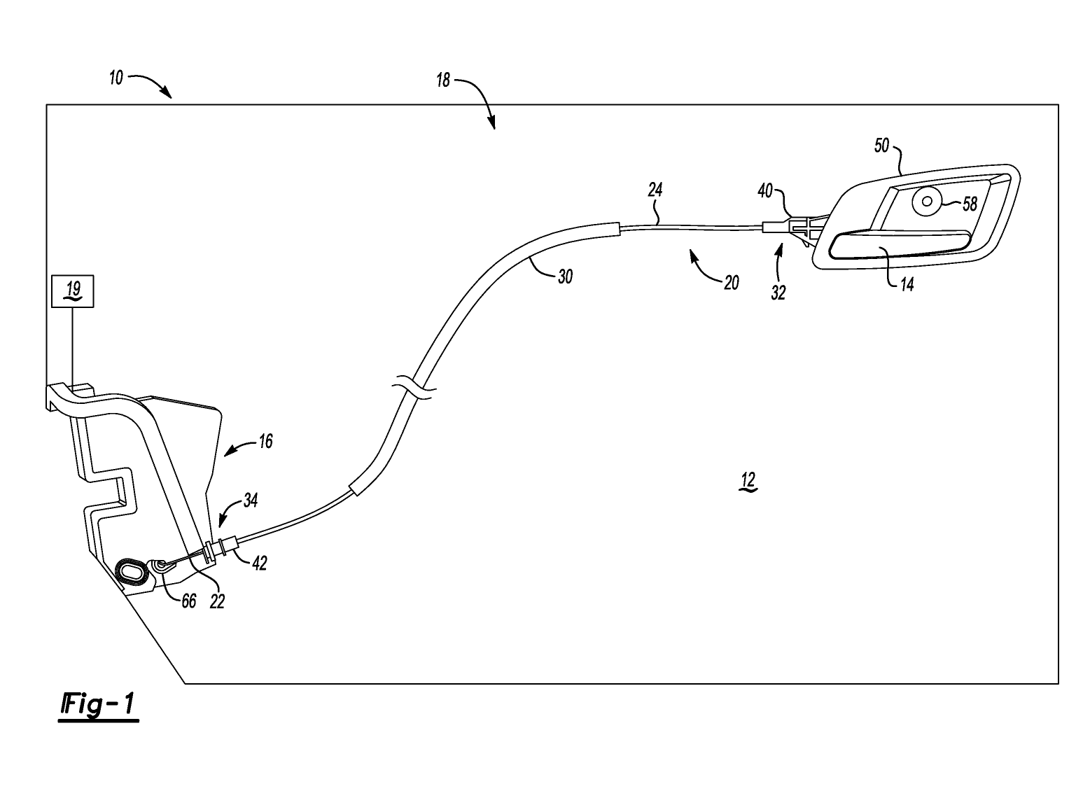

Referring to the drawings, wherein like reference numbers refer to like components, FIG. 1 shows a portion of a vehicle door assembly 10. The assembly 10 includes an interior-facing member 12 and an interior door-release handle 14. The door 10 includes a latch mechanism 16. The latch mechanism 16 is capable of being fastened, such that the door 10 maintains closure of an entryway 18 into the vehicle. The latch mechanism 16 is capable of being released by the handle 14 as well as via an exterior door-release handle 19 to permit the door 10 to open the entryway 18. The latch mechanism 16 may be a unitary or one-piece configuration or may include a plurality of components. The door 10 also includes an inner structure (not shown) for supporting the interior-facing member 12, the latch mechanism 16, and various wiring, reinforcement members and other door hardware, as known by those skilled in the art.

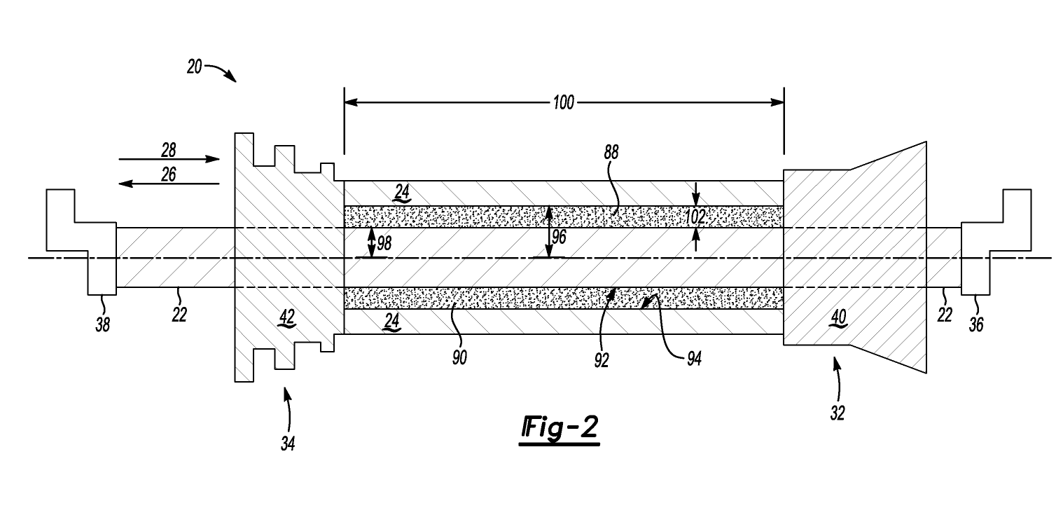

Referring to FIG. 1, the handle 14 is operatively connected to the latch mechanism 16 through a cable assembly 20 for selectively locking, unlocking and unlatching the door 10. FIG. 2 is a schematic sectional view of the cable assembly 20, which includes a wire 22 disposed within a hollow tube or conduit 24. The wire 22 slides or translates in the conduit 24 in the first and second directions 26, 28. Referring to FIG. 2, the movement of the wire 22 relative to the conduit 24 in the first and second directions 26, 28 transmits a pulling or pushing force, in other words, tensile and compressive forces. The conduit 24 is flexible for most of its length. The wire 22 may be composed of a metal such as steel. A sleeve 30 may be placed over the conduit 24 for noise and vibration reduction.

Referring to FIG. 2, a first end 32 of the cable assembly 20 includes a first retaining member 36. A second end 34 of the cable assembly 20 includes a second retaining member 38. The first and second retaining members 36, 38 are configured to attach the wire 22 to various parts of the door assembly 10 (as described below) at the first and second ends 32, 34, respectively. Referring to FIG. 2, the first and second retaining members 36, 38 may be hook-shaped. In one example, the first and second retaining members 36, 38 are composed of a metal.

Referring to FIG. 2, the cable assembly 20 may include first and second connectors 40, 42 configured to attach the conduit 24 to various parts of the door assembly 10 (as described below) at the first and second ends 32, 34, respectively. The conduit 24 is fixed relative to the first and second connectors 40, 42. In one example, the first and second connectors 40, 42 are composed of plastic. The retaining members 36, 38 and connectors 40, 42 may be formed with any shape suitable for the particular application.

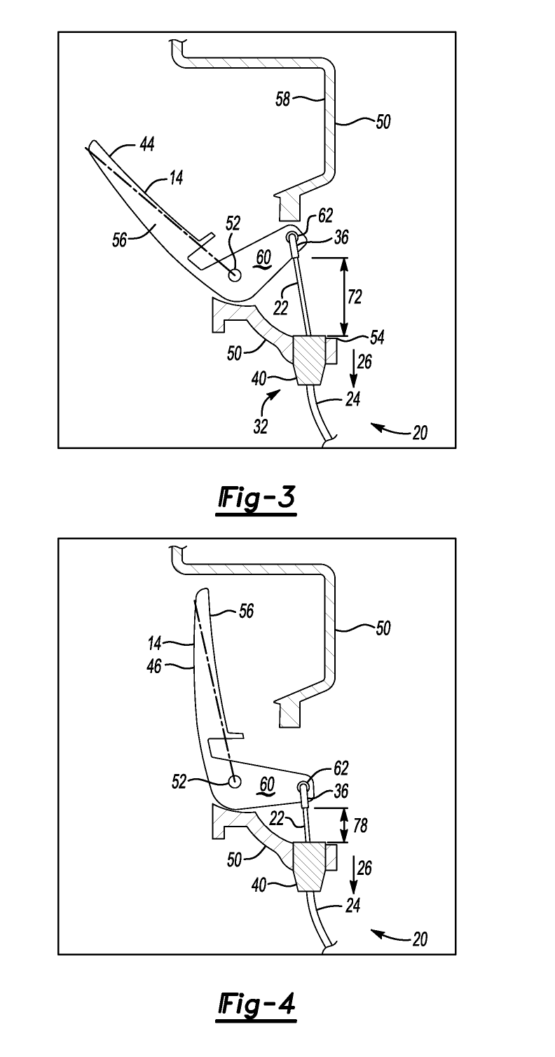

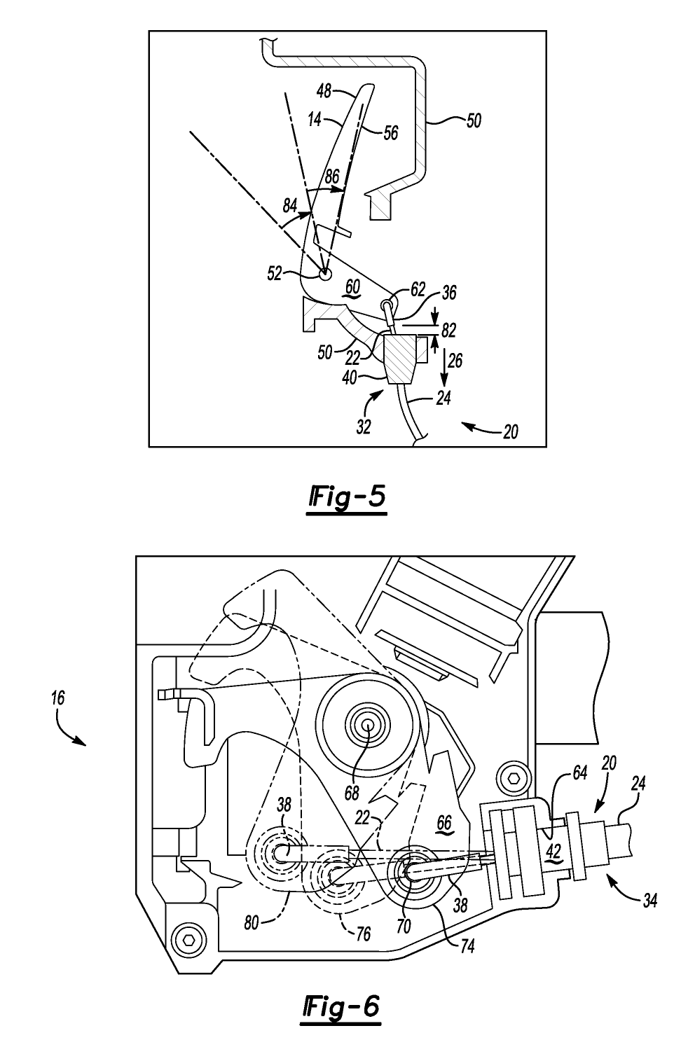

FIGS. 3-5 are schematic sectional views of the handle 14. The handle 14 is movable between at least two positions: a first handle position 44 shown in FIG. 3 where the door assembly 10 is unlatched, and a second handle position 46 shown in FIG. 4 where the door assembly 10 is latched and unlocked. The handle 14 may also be movable to a third handle position 48 shown in FIG. 5 where the door assembly 10 is locked. Referring to FIGS. 3-5, the handle 14 is attached to a base 50 in the interior-facing member 12. The handle 14 may be pivoted about a pivot point 52.

Referring to FIGS. 3-5, the conduit 24 is operatively connected to the handle 14 (through the base 50) through the first connector 40. For example, the first connector 40 may be shaped to fit into a first aperture 54 in the base. The conduit 24 may be rigidly or fixedly attached to the base 50. A first portion 56 of the handle 14 is gripped by an operator (not shown) and is movable away from and towards a recessed wall 58 in the base 50. Referring to FIGS. 3-5, a second portion 60 of the handle 14 is attached to the wire 22 at the first end 32 of the cable assembly 20. In one example, the second portion 60 of the handle 14 includes a slot 62 to which the first retaining member 36 is hooked onto.

FIG. 6 is a schematic sectional view of the latch mechanism 16. Referring to FIGS. 1 and 6, the second end 34 of the cable assembly 20 is operatively connected to the latch mechanism 16. Referring to FIG. 6, the second connector 42 may be inserted into a second aperture 64 in the latch mechanism 16 that is shaped to correspond to the second connector 42. The wire 22 is operatively connected to a latch component 66. Referring to FIG. 6, the latch component 66 may be pivoted about a latch pivot point 68. In one example, the latch component 66 includes a slot 70 to which the second retaining member 38 is hooked onto. Any method of attaching the wire 22 to the latch component 66 and the handle 14 may be employed, e.g., pins, rivets or fasteners. The latch mechanism 16 may include various combinations of springs, gears, cams, levers and other such linkages (not shown) that work together to latch, unlatch, lock and unlock the door assembly 10. Any suitable latch mechanism 16 may be employed.

Referring to FIG. 3, in the first handle position 44, the wire 22 extends a first length 72 out of the conduit 24 at the first end 32 of the cable assembly 20. Referring to FIG. 6, the first handle position 44 corresponds to a first latch position 74 of the latch component 66. Referring to FIG. 4, as the handle 14 is moved or rotated to the second handle position 46, the wire 22 is pushed away from the handle 14 and translates in the direction 26 towards the second end 34 (shown in FIG. 6) of the cable assembly 20. Referring to FIG. 6, the translation of the wire 22 relative to the conduit 24 transmits a pushing force, moving the latch component 66 to a second latch position 76 (shown in phantom) and thereby (directly or indirectly) latching the door assembly 10. Referring to FIG. 4, in the second handle position 46 the wire 22 extends a second length 78 out of the conduit 24 at the first end 32, the second length 78 being less than the first length 72.

Referring to FIG. 5, as the handle 14 is moved to the third handle position 48, the wire 22 is further translated in the direction 26. Referring to FIG. 6, the translation of the wire 18 relative to the conduit 24 transmits a pushing force, moving the latch component 66 to a third latch position 80 (shown in phantom) and thereby (directly or indirectly) locking the door assembly 10. Referring to FIG. 5, in the third handle position 48 the wire extends a third length 82 out of the conduit 24 at the first end 32, the third length 82 being less than the second length 78.

Referring to FIG. 5, the handle 14 defines a first angle 84 as it rotates from the first handle position 44 to the second handle position 46. Referring to FIG. 5, the handle 14 defines a second angle 86 as it rotates from second handle position 46 to the third handle position 48. In one example, the first angle 84 is approximately 32 degrees and the second angle 86 is approximately 15 degrees.

Referring to FIG. 2, a damping material 88 is positioned inside the conduit 24 and at least partially surrounds the wire 22. The damping material 88 is configured to dampen the motion of the handle 14, that is, the damping material 88 makes smooth the movement of the handle 14 between each of its positions 44, 46 and 48. Referring to FIG. 2, the damping material 88 is placed in a clearance 90 between an outer surface 92 of the wire 22 and an inner surface 94 of the conduit 24. The conduit 24 may include multiple layers, in which case the inner surface 94 is the innermost surface of the conduit 24. The damping material 88 may prevent the handle 14 from snapping into the third handle position 48 when released with great force from the first handle position 44.

By way of non-limiting example only, the damping material 88 may be silicone grease. The silicone grease may be made by combining silicone oil with a thickener. The silicone oil may be polydimethylsiloxane. A lithium thickening agent such as polytetrafluoroethylene may be used. In another non-limiting example, the thickener is amorphous fumed silica. Using this formulation, the silicone grease is a viscous paste, with exact properties dependent on the type and proportion of the components. The damping material 88 may be inserted into the clearance 90 at room temperature. The damping material 88 may be inserted into the conduit 24 prior to the wire 22 being inserted.

The damping material 88 is employed with a sufficiently high viscosity to avoid leaking or oozing issues. Viscosity coefficients are typically defined as either dynamic viscosity or kinematic viscosity (dynamic viscosity divided by the density of the material). The unit for dynamic viscosity under ASTM standards is typically centipoise (cP). Water at 20 Celsius has a viscosity of 1.0020 cP. In one example, the viscosity of the damping material 88 is approximately 275,000 cP at 25 Celsius. In another example, the viscosity of the damping material 88 is between approximately 225,000 cP and 325,000 cP at 25 Celsius. Additionally, the damping material 88 is selected from a material that retains its viscosity in the temperature range of operation of the vehicle. The damping material 88 may be selected to retain a viscosity between approximately 225,000 cP and 325,000 cP in the temperature range of approximately −30 to +80 ° C.

The approximate amount of damping material 88 to be employed may be fine-tuned for each particular application. Referring to FIG. 2, the amount D of damping material 88 placed in the clearance 90 may be selected to be: [D=(π·R²−π·r²)(0.4)L], where R is the inner radius 96 of the conduit 24, r is the radius 98 of the wire 22 and L is the overall length 100 of the conduit 24. The damping material 88 may be placed along the entire length 100 of the conduit 24. In one example, the amount D of damping material 88 is 0.3 cc or 0.3 ml, the radius R of the conduit 24 is 2 mm, the length L of the conduit 24 is 500 mm, the radius r of the wire 22 is 1.5 mm and the width 102 of the clearance 90 is approximately 0.5 mm. In another example, r is 3 mm, R is 4.5 mm, L is approximately 600 mm and the width 102 of the clearance 90 is approximately 0.75 mm.

The damping material 88 may be selected to have a dropping point of at least 200 Celsius. The dropping point of a material is generally the temperature at which it passes from a semi-solid to a liquid state under specific test conditions. It is an indication of the type of thickener used, and a measure of the cohesiveness of the oil and thickener employed.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A door assembly comprising:
a handle movable between at least two positions: a first handle position where the door assembly is unlatched and a second handle position where the door assembly is latched;
a hollow conduit operatively connected to the handle;
a wire disposed within the conduit and operatively connected to the handle, wherein the wire translates within the conduit when the handle is moved; and
a damping material positioned between an outer surface of the wire and an inner surface of the conduit, the damping material being configured to dampen the motion of the handle.

2. The assembly of claim 1, further comprising a latch mechanism operatively connected to the wire such that the translation of the wire within the conduit actuates at least one component of the latch mechanism in order to selectively unlatch, latch and lock the door assembly.

3. The assembly of claim 1, wherein the damping material has a viscosity that is between approximately 225,000 cP and 325,000 cP at 25° C.

4. The assembly of claim 1, wherein the damping material has a viscosity that is approximately 275,000 cP at 25° C.

5. The assembly of claim 1, wherein the damping material has a dropping point of at least 200 Celsius.

6. The assembly of claim 1, wherein the damping material is silicone grease.

7. The assembly of claim 6, wherein the silicone grease is composed of polydimethylsiloxane combined with polytetrafluoroethylene.

8. The assembly of claim 6, wherein the silicone grease is composed of polydimethylsiloxane combined with amorphous fumed silica.

9. The assembly of claim 1, wherein the handle is movable to a third handle position where the door assembly is locked.

10. The assembly of claim 9, wherein:
the handle is rotatable about a pivot point between the first, second and third handle positions;
the handle defines a first angle as it moves from the first handle position to the second handle position; and
the handle defines a second angle as it rotates from the second handle position to the third handle position.

11. The assembly of claim 10, wherein the first angle is approximately 32 degrees and the second angle is approximately 15 degrees.

12. The assembly of claim 1, wherein an amount D of the damping material placed in the clearance is [D=(π·R²−π·r²)(0.4)L], where R is an inner radius of the conduit, r is a radius of the wire and L is a length of the conduit.

13. A door assembly comprising:
a handle movable between three positions: a first handle position where the door assembly is unlatched, a second handle position where the door assembly is latched and unlocked, and a third handle position where the door assembly is locked;
a hollow conduit operatively connected to the handle;
a wire disposed within the conduit and operatively connected to the handle, wherein the wire translates within the conduit when the handle is moved; and
a damping material positioned between an outer surface of the wire and an inner surface of the conduit, the damping material being configured to dampen the motion of the handle; and
wherein the damping material has a viscosity that is between approximately 225,000 cP and 325,000 cP at 25° C.

14. The assembly of claim 13, wherein an amount D of the damping material placed in the clearance is [D=(π·R²−π·r²)(0.4)L], where R is an inner radius of the conduit, r is a radius of the wire and L is a length of the conduit.

15. The assembly of claim 13, wherein an amount of damping material placed in the clearance is approximately 0.3 ml, an inner radius of the conduit is 2 mm, a radius of the wire is 1.5 mm and a length of the conduit is 500 mm.

16. A vehicle comprising:
an entryway;
a door assembly for the entryway, the door assembly having:
an interior-facing member;
a handle operatively connected to the interior-facing member and movable between at least two positions;
a hollow conduit operatively connected to the handle;
a wire disposed within the conduit and operatively connected to the handle, wherein the wire translates within the conduit when the handle is moved;
a latch mechanism operatively connected to the wire such that the translation of the wire within the conduit actuates at least one component of the latch mechanism in order to selectively unlatch, latch and lock the door assembly;
a damping material positioned between an outer surface of the wire and an inner surface of the conduit, the damping material being configured to dampen the motion of the handle; and
wherein the damping material is silicone grease.
